(19) United States
(12) Patent Application Publication
(10) Pub. No.: US 2011/0105356 A1
(43) Pub. Date: May 5, 2011

(54) COMPOSITIONS AND METHODS FOR PROVIDING SUBSTANCES TO AND FROM AN ARRAY

(76) Inventors: Chad F. DeRosier, San Diego, CA (US); John A. Moon, San Diego, CA (US); Fiona E. Black, San Diego, CA (US); Robert Yang, San Diego, CA (US); Hongji Ren, San Diego, CA (US); David L. Heiner, San Diego, CA (US)

(21) Appl. No.: 12/991,121

(22) PCT Filed: May 5, 2009
(86) PCT No.: PCT/US2009/042899

§ 371 Date: Dec. 8, 2010

Related U.S. Application Data
(60) Provisional application No. 61/051,323, filed on May 7, 2008.

(51) Int. Cl. C40B 30/04; C40B 50/00; C40B 50/06; C40B 40/00

(52) U.S. Cl. 506/9; 506/27; 506/26; 506/13

(57) ABSTRACT

Methods, kits, systems, and multilayer transfer media for transferring a substance to and from an array are disclosed herein. Also disclosed herein are methods of detecting a substance that has been transferred to an array.

### FIELD OF THE INVENTION

The present invention relates to the field of solid-phase analytical detection. More specifically, the present invention relates to compositions and methods for providing substances to and from an array.

### BACKGROUND

Microarrays have become an increasingly important tool in medicine, biotechnology and related fields. A microarray usually consists of a support that contains numerous capture probes. These capture probes are usually selected for their binding affinity towards their target in a sample presented to the array. After applying the sample to the array the interaction between each probe on an array and its corresponding target can be observed through various labeling and detection techniques, thereby providing qualitative and quantitative data about the target in the tested sample. Microarray technology has been applied to many types of molecules, including DNA, proteins, and chemical compounds. DNA microarrays can provide, for example, a means to analyze the expression of many different genes in a sample simultaneously. Protein microarrays can be exploited to identify molecules that interact with specific proteins. In another example, chemical compound arrays have been used to examine ligands that can bind to particular chemical compounds. While microarrays are emerging as a mature tool, challenges to improve microarray technology remain. Accordingly, there is a continued interest in developing systems and methods to provide more efficient and less expensive tools.

### SUMMARY OF THE INVENTION

Some embodiments of the present invention relate to methods of providing a substance, such as a sample, particle, liquid, catalyst, reagent or molecule, to a surface such as a surface of an array. In particular embodiments, the methods include obtaining an array having a surface comprising a plurality of capture probes and obtaining a preformed porous material, comprising a molecule. The preformed porous material can then be provided to the surface of the array such that the material is in fluid contact with the array surface, thereby transferring the molecule to the array.

In some embodiments of the methods described herein, the capture probes are distributed on the array surface. In certain embodiments, the capture probes can be orderly distributed or randomly distributed on the array surface. When the array is a particle array, the capture probes can be associated with one or a plurality of particles. In such embodiments, the particle or plurality of particles can be distributed on the array surface. In further embodiments, the plurality of particles can be orderly distributed or randomly distributed on the array surface.

The preformed porous material disclosed herein can be made of a variety of materials. In certain embodiments, the preformed porous material can comprise a fibrous material. In other embodiments the preformed porous material can comprise a gel matrix. A natural product such as a sponge or natural fiber can be used. In still other embodiments, the preformed porous material includes, but is not limited to, a polymer selected from the group consisting of gelatin, agarose, pullulan, polyacrylamide, polyvinyl alcohol, polyvinylpyrrolidone, cellulose, polyester, polyolefin, polymethacrylate (PMA) and derivatives of these polymers. In some embodiments, the porous material includes mixtures of such polymers and/or fibers.

Depending on the application, the preformed porous material described herein can be used alone or in combination with other materials. In some embodiments of the methods described herein, the preformed porous material can be attached to a backing layer, such as a non-porous backing. A backing layer is beneficial in embodiments where pressure is applied to the preformed porous material, however, use of a backing layer is not necessarily required for such embodiments.

The pore size of the preformed porous material can vary depending on the application. In some embodiments the preformed porous material has an average pore size from about 1 nm to about 100 μm, from about 100 nm to about 50 μm, or from about 1 μm to about 10 μm. In preferred embodiments, the pore size ranges from about 1 nm to about 10 nm, about 1 nm to about 50 nm or about 1 nm to about 100 nm. Thus, the preformed porous material can have a maximum pore size of about 1 nm, 1 μm, 10 μm, 100 μm or more.

In some of the methods described herein, one or more molecules are transferred to or from a surface, such as the surface of an array, by way of the preformed porous material. In certain embodiments, where the preformed porous material comprises a molecule, the molecule can be dissolved or suspended in a liquid. The preformed porous material can also carry a colloidal solution. In some embodiments, the molecule can be dried or lyophilized. In such embodiments, the molecule can be suspended or dissolved prior to providing the preformed porous material to the surface, such as the surface of an array, by applying a desired solvent to the material. The molecule, which is transferred to or from the surface, such as the surface of an array, by way of the preformed porous material, can essentially be any molecule; however, preferred molecules include nucleic acids, such as sequencing primers and/or hybridization probes. Other preferred molecules include proteins and/or enzymes used for nucleic acid sequencing.

Some embodiments of the present invention relate to methods of performing a binding reaction by supplying a molecule, or multiple different molecules, to a surface, such as a surface of an array, using the preformed porous material. In one embodiment the preformed porous material comprises at least 100 different molecules that can be supplied to the surface, such as the surface of an array. In other embodiments, the preformed porous material comprises least 1,000,000 different molecules that can be supplied to the surface, such as the surface of an array. In one embodiment, the molecule or molecules that are supplied to the array are allowed to bind with at least one of the capture probes of the array. In certain embodiments, the preformed porous material remains in fluid contact with the array surface during the binding reaction. In some embodiments, the preformed porous material can remain in fluid contact with the array surface for a time ranging from less than about 1 minute to more than several days. In a preferred embodiment, the preformed porous material remains in fluid contact with the array surface for less than about 1 hour. In some embodiments, the preformed porous material is removed during the binding reaction. Similarly, a preformed porous material can be contacted with a surface other than an array surface, including, but not limited to, a surface having an analytical probe, wherein a binding reaction or chemical reaction can occur.

Some embodiments of the present invention relate to methods of performing a nucleic acid hybridization by supplying a nucleic acid, or multiple different nucleic acids, to a surface, such as a surface of an array, using a preformed porous material. In particular embodiments, the nucleic acid or nucleic acids that are supplied to the array are allowed to bind with at least one of the capture probes on the array. In preferred embodiments, the capture probes are nucleic acids. In some embodiments, the nucleic acid hybridization is performed at a temperature between about 10° C. and about 90° C., between about 25° C. and about 75° C., or between about 30° C. and about 60° C. In certain embodiments, the preformed porous material remains in fluid contact with the array surface during the hybridization. Similar conditions can be used in embodiments where the preformed porous material is contacted with other surfaces having nucleic acid probes.

In some of the methods described herein, the preformed porous material is removed after providing the material to the surface, such as the surface of an array. In such embodiments, the molecules or other substances that have been transferred may or may not be removed from the surface, such as the surface of an array, when the preformed porous material is removed. In some embodiments, a portion, or even substantially all, of the fluid that has been supplied to the surface, such as the surface of an array, can be removed from the surface, such as the surface of an array, when the preformed porous material in fluid contact with the array or surface is removed. In addition to removing fluid from the surface, such as the surface of an array, by removing such preformed porous material, further removal of fluid can be achieved by providing a dry or substantially non-wetted preformed porous material to the array. In such embodiments the preformed porous material can have a composition that is capable of absorbing the fluid that is on the array or surface.

In some of the methods described herein, a preformed porous material (a first preformed porous material) is provided to the surface, such as the surface of an array, then an additional preformed porous material (second preformed porous material) is provided. In some embodiments, the second preformed porous material can be provided without removing the first preformed porous material from the surface, such as the surface of an array. In other embodiments, the second preformed porous material is provided after the first preformed porous material is removed. In some embodiments, a plurality of preformed porous materials can be provided to the surface, such as the surface of an array, with or without removing previously provided preformed porous materials.

The arrays contemplated herein can be of any size and shape. In preferred embodiments, the array has a planar surface. In other embodiments, the array surface is non-porous, rigid and/or patterned. If desired, a porous array can be used. In preferred embodiments, the array comprises subarrays or is an array of arrays. In such embodiments, the subarrays can be separated from each other by an inter-array spacing on the array surface (inter-array surface). Other exemplary surfaces that can be used include, for example, a multiwell plate, microtiter plate, microscope slide, tissue culture plate or the like.

The preformed porous material can be larger than, approximately the same size as or smaller than the area of the surface, such as the surface of an array. In embodiments utilizing arrays, the preformed porous material is approximately the same area as the area of the surface of the array or a subarray. In some embodiments, the preformed porous material is not in substantial fluid contact with the inter-array surface. In some embodiments, the array comprises alignment moieties to assist in aligning the provided preformed porous material with individual subarrays. Similarly other surfaces can include alignment moieties. Alternatively or additionally, the preformed porous material can include alignment moieties.

In addition to the foregoing methods described herein, systems for transferring a molecule or a plurality of molecules between an array and a preformed porous material are provided. In certain embodiments a system is provided comprising an array and a preformed porous material, wherein the array and preformed porous material are in fluid contact with one another. In some embodiments, the array comprises a plurality of capture probes. In other embodiments, the array comprises a composite array. In still further embodiments, the preformed porous material further comprises a backing layer. In additional embodiments, the preformed porous material comprises one or more molecules. In some embodiments, the preformed porous material further comprises a means to modify the temperature of the preformed porous material and/or array. In some embodiments, a surface other than an array surface is used.

In addition to the foregoing, a kit for providing a substance to a surface, such as a surface of an array, is described. In some embodiments, the kit includes an array having a surface, wherein the array surface comprises a plurality of capture probes. Additionally or alternatively, other surfaces such as a multiwell plate, microtiter plate, microscope slide, tissue culture plate or the like can be included in the kit. Also included in the kit is a preformed porous material. In some embodiments, the preformed porous material comprises at least one molecule that is to be transferred to the array or surface.

In some embodiments of the kits described herein, the capture probes are distributed on an array surface. In certain embodiments, the capture probes can be orderly distributed or randomly distributed on the array surface. When the array is a particle array, the capture probes can be associated with one or a plurality of particles. In such embodiments, the particle or plurality of particles can be distributed on the array surface. In further embodiments, the plurality of particles can be orderly distributed or randomly distributed on the array surface.

As described in connection with the methods set forth herein, the preformed porous material provided in the kits can be made of a variety of materials. For example, in certain embodiments, the preformed porous material can comprise a fibrous material. In other embodiments the preformed porous material can comprise a gel matrix. In still other embodiments, the preformed porous material includes, but is not limited to, a polymer selected from the group consisting of gelatin, agarose, pullulan, polyacrylamide, polyvinyl alcohol, polyvinylpyrrolidone, cellulose, polyester, polyolefin and derivatives of these polymers. In some embodiments, the porous material includes mixtures of such polymers.

The preformed porous materials provided in the kits described herein may or may not comprise other materials. In some embodiments, the preformed porous material can be attached to a backing layer, such as a non-porous backing. In other embodiments, the preformed porous material can be combined with other porous materials.

The pore size of the preformed porous material can vary depending on the application. In some embodiments the preformed porous material has an average pore size from about 1 nm to about 100 μm, from about 100 nm to about 50 μm, or from about 1 μm to about 10 μm. In preferred embodiments, the pore size ranges from about 1 nm to about 10 nm, about 1 nm to about 50 nm or about 1 nm to about 100 nm.

When the preformed porous material provided in the kit comprises a molecule or a plurality of molecules, the molecule or plurality of molecules can be dissolved or suspended in a liquid. Alternatively, the molecule or plurality of molecules can be dried or lyophilized. In addition, some of the kits described herein comprise a reconstitution solvent or solution. In such embodiments, the reconstitution solvent or solution can be used to dissolve or suspend a molecule or a plurality of molecules present in the preformed porous material. In some embodiments, the molecule or plurality of molecules present in the preformed porous material can be, but are not limited to, nucleic acids, sequencing primers and/or a hybridization probes. In some embodiments, the molecule or plurality of molecules can be a protein or an enzyme used for nucleic acid sequencing. Combinations of nucleic acids and proteins may also be provided. In some embodiments of the kits described herein, a molecule or plurality of molecules is provided separately from the preformed porous material. Depending on the application, the molecule or plurality of molecules can be added to the preformed porous material before, during or after providing the preformed porous material to a surface, such as a surface of an array.

Certain kits described herein also comprise one or more additional porous materials. For example, the kit may comprise a surface, such as a surface of an array, along with a first porous material and a second porous material. In some embodiments of such kits, the first porous material comprises one or more molecules. In certain embodiments, the second porous material comprises one or more molecules that can be the same or different from the molecule or plurality or molecules present in the first porous material.

Some of the kits described herein may or may not comprise a temperature regulation system, such as a heating or cooling system. Kits comprising a heating or cooling system can be used to increase or decrease the temperature at which a sample, reagent or molecule is provided to the array.

In addition to the foregoing methods and kits, described herein are multilayer transfer media. For example, some embodiments of the present invention relate to a multilayer transfer medium that comprises a first preformed porous material comprising a first molecule and a second preformed porous material coupled to the first preformed porous material. In some embodiments, the second preformed porous material comprises a second molecule.

With respect to the multilayer transfer media described herein, the first and second preformed porous materials can be made of a variety of materials. For example, in certain embodiments, the first and/or second preformed porous material can comprise a fibrous material. In other embodiments, the first and/or second preformed porous material can comprise a gel matrix. In still other embodiments, the first and/or second preformed porous material includes, but is not limited to, a polymer selected from the group consisting of gelatin, agarose, pullulan, polyacrylamide, polyvinyl alcohol, polyvinylpyrrolidone, cellulose, polyester, polyolefin and derivatives of these polymers. In some embodiments, the porous material includes mixtures of such polymers. In yet another embodiment, the multilayer transfer medium further comprises a backing layer, such as a non-porous backing.

The pore size of the preformed porous material of the multilayer transfer medium can vary depending on the application. In some embodiments the preformed porous material has an average pore size or range of pore sizes as described herein with regard to other preformed porous materials. The average pore size, minimum pore size or maximum pore size for two or more preformed porous materials of a multilayer transfer medium can be the same as each other or different from each other. For example, the pore size can be from about 1 nm to about 100 μm, from about 100 nm to about 50 μm, or from about 1 μm to about 10 μm. In preferred embodiments, the pore size ranges from about 1 nm to about 50 nm.

In some embodiments of the multilayer transfer media described herein, the first preformed porous material comprises a first molecule or a first plurality of molecules that can be dissolved or suspended in a liquid. Alternatively, the first molecule or first plurality of molecules can be dried or lyophilized. In some embodiments, the second preformed porous material comprises a second molecule or a second plurality of molecules that can be dissolved or suspended in a liquid. Alternatively, the second molecule or second plurality of molecules can be dried or lyophilized.

In some embodiments, the first and/or second molecule or first and/or second plurality of molecules present in the first and/or second preformed porous materials can be, but are not limited to, nucleic acids, sequencing primers and/or a hybridization probes. In some embodiments, the first and/or second molecule or first and/or second plurality of molecules can be a protein, a cation or an enzyme used for nucleic acid sequencing. Combinations of nucleic acids, proteins and cations may also be provided. In some embodiments the first molecule or first plurality of molecules is the same as the second molecule or second plurality of molecules. In other embodiments, the first molecule or first plurality of molecules is different from the second molecule or second plurality of molecules.

Additional embodiments of the multilayer transfer medium further comprise one or more additional porous materials, wherein the one or more additional porous materials comprises one or more additional molecules. The one or more additional molecules may be the same as, or different from, the first and/or second molecules present in the multilayer transfer medium.

In addition to the foregoing compositions and methods described herein, the present invention relates to methods for detecting a molecule transferred to a surface, such as a surface of an array. The methods can include the step of obtaining an array having a surface comprising a plurality of capture probes. The methods can also include the step of obtaining a preformed porous material comprising a molecule and then providing the preformed porous material to the surface of the array such that the preformed porous material is in fluid contact with the surface. In such methods, the molecule becomes bound to at least one of the capture probes provided that the array includes one or more capture probes capable of binding the molecule. The molecule bound to the capture probe is then detected, for example, by detecting a change in an optical signal. Alternatively or additionally, a change to the probe and/or the binding molecule that occurs as a result of the binding can be detected such as an enzymatic modification to add a labeled nucleotide or oligonucleotide to the probe or target in a probe target hybrid. Similar steps can be carried out by contacting preformed porous materials to other surfaces.

In some embodiments, the methods for detecting the molecule further comprise removing the preformed porous material from the surface, such as the surface of the array, before detecting binding of the molecule to the capture probe. However, the material need not be removed in embodiments where detection can be carried out with the material in place.

In an additional embodiment, the detecting comprises measuring a change in an optical signal. In another embodiment, detecting the molecule is performed prior or subsequent to decoding the location of a molecule bound to a capture probe on the surface of an array. In yet another embodiment, detecting the molecule includes sequencing the molecule bound to the capture probe. In some embodiments, the molecule need not be bound directly to a capture probe but can be bound through one or more intermediate molecules. In some embodiments, detecting can be achieved by detecting a secondary reaction or product of such a reaction occurring at a probe or elsewhere in a solution surrounding a probe.

### BRIEF DESCRIPTION OF THE DRAWINGS

FIG. 1 is a plan view of an array comprising subarrays.

FIG. 2 is an elevation view of a backed preformed porous material in fluid contact with an array surface.

FIG. 3 is an elevation view of a preformed porous material inset into a backing and in fluid contact with an array surface.

FIGS. 4A and 4B are elevation views of preformed porous materials in fluid contact with arrays of arrays.

FIG. 5 A is an elevation view of an array aligned with a preformed porous material using alignment moieties.

FIGS. 5B and 5C are elevation views of arrays of arrays aligned with a preformed porous material using alignment moieties.

FIGS. 6A and 6B are elevation views of multilayer transfer media.

### DETAILED DESCRIPTION

Some of the embodiments of the invention described herein relate to methods for supplying substances to and/or removing substances from arrays. These embodiments utilize preformed porous materials that can be provided to an array surface such that the preformed porous material is in fluid contact with the array surface. Such fluid contact permits the transfer of substances including, but not limited to, samples, solvents, reagents and other molecules to and from the array.

Other embodiments described herein relate to compositions for supplying substances to and/or removing substances from arrays. In some embodiments, the compositions include kits containing an array and one or more preformed porous materials. Kits may also include additional items, such as reagents, solvents, and temperature regulation systems.

In addition to single layer preformed porous materials, also described herein are multilayer transfer media comprising at least a first porous material coupled to a second porous material. In embodiments in which the multilayer transfer medium is hydrated, the first and second materials can be in fluid contact with each other. Multilayer transfer media can be used in any of the compositions and/or methods described herein.

Additional compositions described herein relate to array systems comprising an array having one or more surfaces in fluid contact with a preformed porous material. In such systems, the preformed porous material can be backed or unbacked. Array systems described herein may also comprise an array having one or more surfaces in fluid contact with a multilayer transfer medium.

Methods of detecting one or more molecules are also provided herein. Such methods comprise obtaining an array having a plurality of capture probes to which one or more molecules can either directly or indirectly (that is, through an intermediate molecule) bind. A preformed porous material comprising one or more molecules is provided to the array such that it is in fluid contact with a surface of the array. Molecules from the preformed porous material are transferred to the array and become available for binding by one or more capture probes. Molecules bound to capture probes, either directly or through intermediate molecules that are supplied to the array, can then be detected.

In some embodiments, the compositions and/or methods described herein provide a means by which to reduce the volume of sample and/or reagent that is provided to the array.

Systems, kits, compositions and methods described herein can include or utilize some or all of the following: an array, a preformed porous material, a backing layer, moieties for aligning the preformed porous materials with the array, a temperature regulation system and one or more samples, solvents, reagents and/or other molecules. Each of these components are described in detail below.

The detailed description that follows illustrates some exemplary embodiments of the disclosed invention. Those of skill in the art will recognize that there are numerous variations and modifications of this invention that are encompassed by its scope. Accordingly, the description of a certain exemplary embodiment should not be deemed to limit the scope of the present invention. For example, several embodiments of the methods and compositions of the invention are exemplified herein with respect to arrays. It will be understood that arrays can be replaced with other substrates or surfaces. In particular embodiments, the exemplified arrays can be replaced with multiwell plates or microtiter plates. Thus, an Enzyme-Linked ImmunoSorbent Assay (ELISA) can be carried out using the compositions and methods set forth herein. Similarly, a microscope slide or tissue culture plate can be used, for example, to deliver or remove liquids for purposes of detecting cells or other biological components that are on the surface of the slide or plate.

### Arrays

An array refers to a solid support comprising a plurality of capture probes at spatially distinguishable locations. Arrays can have one or more surfaces on which capture probes are distributed. In some embodiments, all of the capture probes distributed on an array surface are identical to each other. In other embodiments, some of the capture probes distributed on the array surface are identical to each other but different from one or more other capture probes distributed on the array surface. In still other embodiments, most or all of the capture probes distributed on an array surface are different from each other.

In embodiments where capture probes are distributed on an array surface, the capture probes can be distributed at discrete sites. In some embodiments, a discrete site is a feature having a plurality of copies of a particular capture probe. Thus, an array can comprise a plurality of discrete sites or features. In some embodiments, a space separates each discrete site from another such that the discrete sites are noncontiguous. In other embodiments, the discrete sites are contiguous. For some of the arrays described herein, discrete sites can be present on the array surface at a density of greater than 10 discrete sites per square millimeter. For other arrays, discrete sites can be present on the array surface at a density of greater than 100 discrete sites per square millimeter, greater than 1000 discrete sites per square millimeter, greater than 10,000 discrete sites per square millimeter, greater than 100,000 discrete sites per square millimeter, greater than 1,000,000 discrete sites per square millimeter, greater than 10,000,000 discrete sites per square millimeter, greater than 100,000,000 discrete sites per square millimeter or greater than 1,000,000,000 discrete sites per square millimeter.

As used herein, the term “capture probes” means molecules that are associated with an array. The capture probes are molecules that bind, hybridize or otherwise interact with one or more molecules that are transferred to the array. In preferred embodiments, the capture probes are short nucleic acids or oligonucleotides. In such embodiments, the short nucleic acids or oligonucleotides have an average length of 5 nucleotides, 6 nucleotides, 7 nucleotides, 8 nucleotides, 9 nucleotides, 10 nucleotides, 11 nucleotides, 12 nucleotides, 13 nucleotides, 14 nucleotides, 15 nucleotides, 16 nucleotides, 17 nucleotides, 18 nucleotides, 19 nucleotides, 20 nucleotides, 21 nucleotides, 22 nucleotides, 23 nucleotides, 24 nucleotides, 25 nucleotides, 26 nucleotides, 27 nucleotides, 28 nucleotides, 29 nucleotides, 30 nucleotides, 31 nucleotides, 32 nucleotides, 33 nucleotide, 34 nucleotides, 35 nucleotides, 36 nucleotides, 37 nucleotides, 38 nucleotides, 39 nucleotides, 40 nucleotides, 41 nucleotides, 42 nucleotides, 43 nucleotides, 44 nucleotides, 45 nucleotides, 46 nucleotides, 47 nucleotides, 48 nucleotides, 49 nucleotides, 50 nucleotides, 51 nucleotides, 52 nucleotides, 53 nucleotides, 54 nucleotides, 55 nucleotides, 56 nucleotides, 57 nucleotides, 58 nucleotides, 59 nucleotides, 60 nucleotides, 61 nucleotides, 62 nucleotides. 63 nucleotides, 64 nucleotides, 65 nucleotides, 66 nucleotides, 67 nucleotides, 68 nucleotides, 69 nucleotides, 70 nucleotides, 71 nucleotides, 72 nucleotides, 73 nucleotides, 74 nucleotides or 75 nucleotides. In other embodiments, oligonucleotides have an average length of greater than 75 nucleotides.

With respect to some of the arrays described herein, the capture probes are coupled to an array surface. Such coupling can be via a direct attachment of the capture probe to the array surface. Direct attachment can include, but is not limited to, covalent attachment, non-covalent attachment, and adsorptive attachment. Alternatively, capture probes can be attached to the array surface via one or more intermediate molecules or particles.

Depending on the deposition method, the capture probes can be distributed on the array surface in either a random or ordered distribution. For example, in some embodiments, capture probes are synthesized directly on the array surface such that the position of each capture probe is known. In such embodiments, the capture probes can be synthesized in any order that is desired. For example, capture probes may be grouped by functionality or binding affinity for a particular molecule. In other embodiments, the capture probes are synthesized then coupled to an array surface. In such embodiments, the capture probes can be coupled to specific areas of the array surface such that the specific areas of the array surface comprise a defined set of capture probes.

With respect to other arrays described herein, capture probes are not attached directly to the array, but rather, they are associated with the array through intermediate structures, such as particles. In such embodiments, a plurality of particles is distributed on the array. The plurality of particles can comprise particles that have one or more capture probes coupled thereto, as well as particles that do not have any capture probes coupled thereto. In some embodiments, all particles of the plurality of particles have one or more identical capture probes coupled thereto. In certain embodiments, where pluralities of particles are used, the capture probes coupled the particles are identical to each other such that all particles have the same identical capture probes coupled thereto. In other embodiments, where pluralities of particles are used, some or all of the capture probes coupled the particles are different from each other such that some particles have capture probes coupled thereto that are different from the capture probes attached to other particles. In preferred embodiments, the particles are inanimate, non-living beads or microspheres.

In certain embodiments of the present invention, a plurality of particles are distributed on the surface of an array. In some embodiments, the particles are distributed on the array such that one or more particles end up in a depression present on the array. In some embodiments, the depressions are configured to hold a single particle. In other embodiments, the depressions are configured to hold thousands, or even millions, of particles.

The plurality of particles can be distributed on the array so that they are orderly or randomly distributed. In particular embodiments, an array can comprise a particle-based analytic system in which particles carrying different functionalities are distributed on an array comprising a patterned surface of discrete sites, each capable of binding an individual particle.

Arrays described herein can have a variety of surfaces. Arrays having planar surfaces or surfaces with one or more depressions, channels or grooves are particularly useful. In addition, some of the arrays have a non-porous surface. In some embodiments, the entire array is non-porous. In other embodiments, the array has at least one porous or semi-porous surface but is primarily non-nonporous.

Surfaces can have contours or other features that match the contours or features of a preformed porous material such that when pressure is placed on the material there will be localized areas of relatively high and relatively low pressure. This will allow different delivery rates because areas of localized high pressure will have an increased rate of liquid delivery compared to areas of lower pressure. For example, a preformed porous material having a flat surface can be contacted with a surface having depressions or channels such that lower pressure occurs at the depressions or channels. This in turn results in a slower delivery of fluid to the depressions than to the raised area. Thus, fluid can be delivered more rapidly to the raised areas on the surface.

Preferred array materials include, but are not limited to glass, silicon, plastic or non-reactive polymers. Arrays described herein can be rigid or flexible. In some embodiments, the array is rigid, whereas in other embodiments, the array is not rigid but comprises at least one rigid surface. Other arrays contemplated herein can comprise a flexible array substrate having a flexible support, such as that described in U.S. patent application Ser. No. 10/285,759, the disclosure of which is hereby incorporated expressly by reference in its entirety.

Some of the arrays described herein include one or more patterned surfaces. In some embodiments, the array surface can comprise one or more discrete sites. In certain embodiments, the discrete sites can be depressions, such as wells, grooves, channels or indentations. Depressions can be sized so as to accommodate as few as one particle or as many as several million particles.

In further embodiments an array can comprise a composite array (array of subarrays) as described in U.S. Pat. No. 6,429,027 or U.S. Pat. No. 5,545,531, the disclosures of which are hereby incorporated expressly by reference in their entirety. Composite arrays can comprise a plurality of individual arrays on a surface of the array or distributed in depressions present on the array surface. The plurality of individual arrays on a surface of the array or distributed in depressions present on the array surface can be referred to as subarrays. For example, in a composite array, a single subarray can be present in each of a plurality of depressions present on the array. In other embodiments, multiple subarrays can be present in each depression of a plurality of depressions present on the array. Individual subarrays can be different from each other or can be the same or similar to other subarrays present on the array. Accordingly, in some embodiments, the surface of a composite array can comprise a plurality of different and/or a plurality of identical, or substantially identical, subarrays. Moreover, in some embodiments, the surface of an array comprising a plurality of subarrays can further comprise an inter-subarray surface. By “inter-subarray surface” or “inter-subarray spacing” is meant the portion of the surface of the array not occupied by subarrays. In some embodiments, “inter-subarray surface” refers to the area of array surface between a first subarray and an adjacent second subarray.

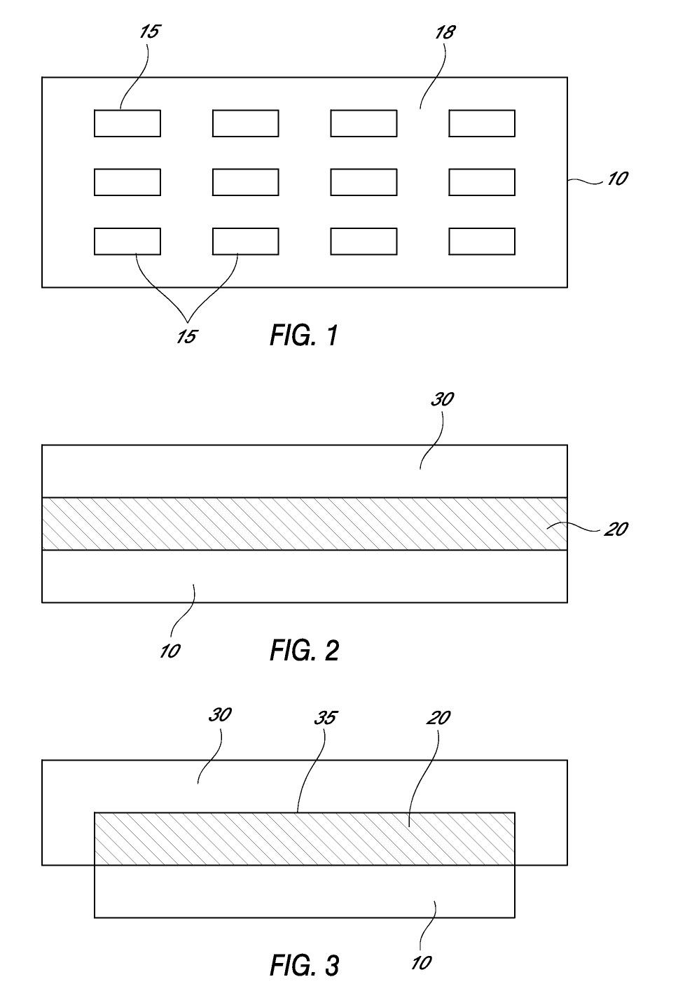

FIG. 1 shows an array (10) having twelve individual subarrays (15) present on the array surface. The inter-subarray surface (18) is indicated between two of the adjacent subarrays.

Subarrays can include some or all of the features of the arrays described herein. For example, subarrays can include depressions that are configured to contain one or more particles. Moreover, subarrays can further comprise their own subarrays.

Exemplary arrays that can be contacted with a preformed porous material include, without limitation, those in which beads are associated with a solid support, examples of which are described in U.S. Pat. No. 6,355,431; U.S. Pat. No. 6,327,410; U.S. Pat. No. 6,770,441; US Published Patent Application No. 2004/0185483; US Published Patent Application No. 2002/0102578 and PCT Publication No. WO 00/63437, each of which is hereby incorporated by reference. Beads can be located at discrete locations, such as wells, on a solid-phase support, whereby each location accommodates a single bead.

Any of a variety of other arrays known in the art or methods for fabricating such arrays can be used. Commercially available microarrays that can be used include, for example, an Affymetrix® GeneChip® microarray or other microarray synthesized in accordance with techniques sometimes referred to as VLSIPS™ (Very Large Scale Immobilized Polymer Synthesis) technologies as described, for example, in U.S. Pat. Nos. 5,324,633; 5,744,305; 5,451,683; 5,482,867; 5,491,074; 5,624,711; 5,795,716; 5,831,070; 5,856,101; 5,858,659; 5,874,219; 5,968,740; 5,974,164; 5,981,185; 5,981,956; 6,025,601; 6,033,860; 6,090,555; 6,136,269; 6,022,963; 6,083,697; 6,291,183; 6,309,831; 6,416,949; 6,428,752 and 6,482,591, each of which is hereby incorporated by reference in its entirety. A spotted microarray can also be used in a method of the invention. An exemplary spotted microarray is a CodeLink™ Array available from Amersham Biosciences. Another microarray that is useful in the invention is one that is manufactured using inkjet printing methods such as SurePrint™ Technology available from Agilent Technologies.

In a particular embodiment, clustered arrays of nucleic acid colonies can be prepared as described in U.S. Pat. No. 7,115,400; US Published Patent Application No. 2005/0100900 A1; PCT Publication No. WO 00/18957 or PCT Publication No. WO 98/44151 (the contents of which are herein incorporated by reference). Such methods are known as bridge amplification or solid-phase amplification and are particularly useful for sequencing applications.

### Preformed Porous Material

A preformed porous material provides a means to transfer a substance to or from an array, when the preformed porous material is in fluid contact with the array. In certain embodiments, a preformed porous material can comprise a molecule or plurality of molecules to be transferred to an array. In other embodiments, a preformed porous material can further comprise a backing layer, alignment moieties, or a composition or device that is used to modify the temperature of the preformed porous material and/or surface of the array.

Preformed porous materials can be composed from various types of materials. The composition of the preformed porous material can be chosen to be compatible with the conditions under which the array and preformed porous material will be used. For example, the preformed porous material can be made to be compatible with one or more factors, including, for example, the temperature range, pH range, or solvents used in binding reactions, hybridization reactions, chemical reactions, enzymatic modifications, washing steps, and/or array recycling or regeneration steps.

Typically, in order to facilitate transfer, the porous material has a low binding affinity for the molecules and/or other substances transferred between the array and porous material. In preferred embodiments, the porous material can be hydrophilic. However, the preformed porous material can have hydrophobic characteristics in some embodiments, especially, where hydrophobic substances are transferred.

In some embodiments described herein, the preformed porous material is a fibrous material. In other embodiments, the preformed porous material can be a gel matrix. Non-limiting examples of compositions that can be used to prepare preformed porous materials include polymers such as gelatin, agarose, pullulan, polyacrylamide, polyvinyl alcohol, polyvinylpyrrolidone, cellulose, polyester, polyolefin, polysaccharides or derivates of the aforementioned polymers. Additionally, a preformed porous material can comprise mixtures of various constituents, such as a mixture of polymers and/or polymer derivatives. The properties of the gel or fiber used in a preformed porous material can be selected to aid in active or passive material transfer. For example, as set forth in further detail below the porosity, hydrophobicity or hydrophilicity of the material can be selected to influence delivery rate of direction of delivery for a substance of interest.

In preferred embodiments, the preformed porous material is prepared or assembled before contacting the material with an array. In some embodiments, for example, where the preformed porous material comprises a polymer, the precursor constituents to the polymer can undergo polymerization prior to contacting the polymerized preformed porous material to the array. In such embodiments, the time between polymerizing the precursor polymer constituents and contacting the preformed porous material to the surface of an array can be more than about 1 second, 1 minute, 1 hour, 1 day, or 1 week. In other embodiments, a preformed porous material can be contacted to an array immediately subsequent to the time of polymerization. The porosity or other characteristic of the preformed porous material can change before, during or after being contacted with an array surface. Thus, a preformed porous material need not be in its final form prior to being contacted with an array surface.

In some embodiments of the present invention, the preformed porous material comprises a substance that is transferred, or that is to be transferred, to an array. In other embodiments, the preformed porous material comprises a substance that is transferred or removed from an array. The substance can include, but is not limited to, one or more molecules, such as target molecules, polymerase, primers, probes, reagents, cofactors, reactants, enzymes, nucleotides, complexes and/or products. Substances can also include the samples, preparations, solvents, liquids or other fluids in which one or more target molecules, primers, probes, reagents, cofactors, reactants, complexes and/or products are dissolved or suspended. In certain embodiments, the preformed porous material can comprise a plurality of different substances.

The substances for use with the preformed porous materials described herein can be present in one or more physical states. For example, in some embodiments, the substance can comprise a liquid. Alternatively, in other embodiments, the substance can be dried or lyophilized. A substance may be dried or lyophilized, for example, to maintain the shelf-life of the substance, or to maintain the substance in an inactive state. Where the substance is dried or lyophilized, the preformed porous material comprising the substance can be wetted prior to transfer between the preformed porous material and array. In some embodiments, wetting the preformed porous material can dissolve or suspend the substance, activate an inactive substance, and/or provide for a fluid contact between the preformed porous material and array.

In preferred embodiments of the present invention, the preformed porous material comprises a substance that is, or includes, a molecule. By “molecule” is meant, any chemical compound or plurality of chemical compounds that is/are transferred, or is/are to be transferred, from the preformed porous material to the array. Typically, the molecules are soluble in the fluid that mediates the contact between the preformed porous material and the array surface. In some embodiments, molecules are limited to chemical compounds that have a binding affinity to one or more of the plurality of capture probes present on the array or that are suspected of having such binding affinity. This affinity can be specific, or in some embodiments, non-specific.

In preferred embodiments, where a substance, such as a molecule or plurality of molecules, is transferred from the preformed porous material to the array, the substance is one that is useful in microarray analyses, such as hybridization reactions, binding reactions, or sequencing reactions. Non-limiting examples of such substances include a molecule, such as a protein, antibody, enzyme, polypeptide, amino acid, nucleic acid, DNA, RNA, oligonucleotide, nucleotide or antigen. In some preferred embodiments, the molecule can be a sequencing primer, a hybridization probe, or an enzyme used for nucleic acid sequencing.

In other embodiments where a substance is transferred from the array to the preformed porous material, the substance is often a solvent or other fluid that is removed from the surface of the array. In some embodiments, the fluid includes one or more molecules, such as dissolved molecules that did not bind to a capture probe. Alternatively or additionally, the fluid that is removed can include products of a reaction carried out on an array, unused reactants, enzymes or mixtures thereof.

Where a preformed porous material comprises a substance to be transferred to an array, the substance can be provided to the preformed porous material using a variety of methods. In some embodiments, the substance can be provided to the porous material as the porous material is prepared or assembled. In embodiments where the preformed porous material comprises a polymer, for example, the substance can be mixed with the precursor constituents of the polymer before or during polymerization and preparation of the preformed porous material. In other embodiments, the substance can be provided to the preformed porous material subsequent to the preparation or assembly of the preformed porous material. For example, the substance can be provided to the preformed porous material at a time prior to, or while, the preformed porous material is in fluid contact with the array. Generally, the time between providing a preformed porous material with a substance, and transferring the substance to an array can be determined by factors such as the stability of the substance, and the stability of the preformed porous material. In some embodiments, the time between providing the preformed porous material with a substance and contacting the surface of the array with the preformed porous material comprising the substance can be about the same time, less than about 1 minute, less than about 10 minutes, less than about 1 hour, and less than about 3 days. In other embodiments, the time between providing the porous material with the substance and contacting the array with the preformed porous material comprising the substance can be greater than about 3 hours, greater than about 3 days, greater than about 3 weeks, greater than about 3 months, greater than about 1 year, or greater than about 3 years.

In embodiments where a liquid is provided to the preformed porous material, the liquid can be applied to the preformed porous material directly, for example, by soaking the preformed porous material in the liquid, pipetting the liquid on to the preformed material, or spraying the liquid on to the preformed porous material. In other embodiments, a liquid can be provided to a first performed porous material from a second preformed porous material in fluid contact with the first preformed porous material. In such embodiments, transfer of the liquid can be facilitated by any of a number of forces, including, for example, diffusion, gravity, cohesion, osmosis, centrifugal, or mechanical force.

In some embodiments of the present invention, dry substances can be provided to the preformed porous material directly by, for example, spraying, spotting or dusting the substance on to the preformed porous material. In other embodiments, a dried or lyophilized substance can be dissolved or suspended in a liquid before providing the liquid to the preformed porous material. In some such embodiments, the preformed porous material comprising the substance can subsequently be dried or lyophilized, for example, to maintain the stability of the substance.

With respect to the dimensions, in some embodiments, the preformed porous material can cover all or substantially all (for example, more than 85%) of the surface of the array. In other embodiments, the preformed porous material can be larger than, smaller than, or about the same size as the surface of the array. In preferred embodiments, the preformed porous material can cover at least the surface of the array occupied by capture probes. In further preferred embodiments, the preformed porous material can cover at least one subarray on the surface of a composite array. In especially preferred embodiments, the preformed porous material is configured such that it covers one or more subarrays but it does not substantially overlap with the inter-subarray surface.

The thickness, density and porosity of the preformed porous material can be modified depending on the application. In some embodiments, the thickness and density of a preformed porous material is determined by factors such as, for example, the volume to be transferred between a preformed porous material and an array. In other embodiments, the porosity of the porous material is determined by factors such as, for example, the molecular size of a substance to be transferred. Porosity of a preformed porous material can be controlled, for example, where the preformed porous material comprises a polymer, by manipulating the degree of polymerization. In some embodiments, the preformed porous material can have an average pore size from about 1 nm to about 100 μm. In some embodiments, the average pore size is from about 1 nm to about 100 nm. In preferred embodiments, the average pore size is from about 1 nm to about 10 nm. In other embodiments, the average pore size is from about 100 nm to about 50 μm. In still other embodiments, the average pore size is from about 1 μm to about 10 μm. In preferred embodiments, the average pore size of the preformed porous material is about 1 nm, about 2 nm, about 3 nm, about 4 nm, about 5 nm, about 6 nm, about 7 nm, about 8 nm, about 9 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 125 nm, about 150 nm, about 175 nm, about 200 nm, about 225 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1000 nm, about 1500 nm, about 2000 nm, about 2500 nm, about 3000 nm, about 3500 nm, about 4000 nm, about 4500 nm, about 5000 nm, about 5500 nm, about 6000 nm, about 6500 nm, about 7000 nm, about 7500 nm, about 8000 nm, about 8500 nm, about 9000 nm, about 9500, about 10,000 nm or more than about 10,000 nm. In other preferred embodiments, the average pore size of the preformed porous material can be less than about 1 nm.

In some alternative embodiments of the present invention, the pore size of the preformed porous material can be measured or characterized by an exclusionary value or molecular weight cutoff. Such exclusionary value corresponds to the molecular mass of molecules which typically cannot pass through the pores. For example, an exclusionary value of 10 kilodaltons (kD) refers to an average pore size that will permit only molecules with a molecular weight of less than about 10,000 Daltons to pass. Molecules with a molecular weight substantially greater than 10 kD with not typically pass through the pores. In some embodiments, the average pore size of the preformed porous material will have an a molecular weight cutoff ranging from 1 kD to 10,000 kD. In preferred embodiments, the molecular weight cutoff is about 1 kD, about 5 kD, about 10 kD, about 15 kD, about 20 kD, about 25 kD, about 30 kD, about about 35 kD, about 40 kD, about 45 kD, about 50 kD, about 55 kD, about 60 kD, about 65 kD, about 70 kD, about 75 kD, about 80 kD, about 85 kD, about 90 kD, about 95 kD, about 100 kD, about 125 kD, about 150 kD, about 175 kD, about 200 kD, about 225 kD, about 250 kD, about 300 kD, about 350 kD, about 400 kD, about 450 kD, about 500 kD, about 550 kD, about 600 kD, about 650 kD, about 700 kD, about 750 kD, about 800 kD, about 850 kD, about 900 kD, about 950 kD, about 1000 kD or more than 1000 kD.

In addition to the foregoing, it is contemplated that by manipulating the density and porosity of the preformed porous material, the material can be made selective for molecules of certain sizes. In some such embodiments, for example, a preformed porous material can be made with an average pore size that is between the average diameter of two or more molecules so that on fluid contact with an array, only molecules having an average diameter smaller than a specific pore size are transferred to the preformed porous material. Thus, the porosity of a preformed porous material can have a size cutoff of about 1 nm, 1 μm, 10 μm, 100 μm or more. In preferred embodiments, the average pore size of the preformed porous material is about 1 nm, about 2 nm, about 3 nm, about 4 nm, about 5 nm, about 6 nm, about 7 nm, about 8 nm, about 9 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 125 nm, about 150 nm, about 175 nm, about 200 nm, about 225 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1000 nm, about 1500 nm, about 2000 nm, about 2500 nm, about 3000 nm, about 3500 nm, about 4000 nm, about 4500 nm, about 5000 nm, about 5500 nm, about 6000 nm, about 6500 nm, about 7000 nm, about 7500 nm, about 8000 nm, about 8500 nm, about 9000 nm, about 9500, about 10,000 nm or more than about 10,000 nm. In other preferred embodiments, the average pore size of the preformed porous material can be less than about 1 nm. In other preferred embodiments, the average pore size of the preformed porous material will have an a molecular weight cutoff ranging from 1 kD to 10,000 kD. In preferred embodiments, the molecular weight cutoff is about 1 kD, about 5 kD, about 10 kD, about 15 kD, about 20 kD, about 25 kD, about 30 kD, about about 35 kD, about 40 kD, about 45 kD, about 50 kD, about 55 kD, about 60 kD, about 65 kD, about 70 kD, about 75 kD, about 80 kD, about 85 kD, about 90 kD, about 95 kD, about 100 kD, about 125 kD, about 150 kD, about 175 kD, about 200 kD, about 225 kD, about 250 kD, about 300 kD, about 350 kD, about 400 kD, about 450 kD, about 500 kD, about 550 kD, about 600 kD, about 650 kD, about 700 kD, about 750 kD, about 800 kD, about 850 kD, about 900 kD, about 950 kD, about 1000 kD or more than 1000 kD.

In certain embodiments, the preformed porous material can include a backing layer. A backing layer refers to a layer attached to the preformed porous material. In some embodiments, the backing layer provides a structure by which to handle the preformed porous material without directly contacting the porous material, by which to protect the preformed porous material, and/or by which to direct transfer of a substance between the preformed porous material and the array surface. The backing can be impermeable to liquids and/or at least one substance carried by the liquid. The backing can be selectively impermeable to particular types of liquids for example being hydrophobic to prevent passage of aqueous liquids or being hydrophobic to prevent passage of organic solvents or non-polar liquids. The backing layer can provide the advantage of preventing or at least reducing unwanted evaporation of liquids contained in the preformed porous material. In some embodiments, the backing layer can further include a device or composition, such as an electrical or chemical heat source, that can be used to modify the temperature of the preformed porous material and/or array.

In certain preferred embodiments, the backing layer can comprise a non-porous material, which is also termed a non-porous backing. Independent of whether the backing layer is porous or non-porous, it can be constructed of either flexible or rigid material. In some embodiments, the backing layer can comprise a variety of materials that can include, for example, elastomers, such as rubber, and other flexible polymers.

Attachment of the backing layer to the preformed porous material can be mediated using any of the conventional methods known in the art for surface attachment, such as adhesives, mechanical clamps or graft polymerization. In some embodiments, the backing layer can be attached directly to the preformed porous material. In other embodiments, the backing layer is attached to an intermediate material that is attached to the preformed porous material. If a heating or cooling source is to be used as described hereinafter in connection with certain embodiments of the invention, attachment of the backing layer to the preformed porous material should be mediated using an attachment that is impervious to decomposition upon heating or cooling applications. In some embodiments, a preformed porous material is manufactured directly together with the backing layer.

While a single preformed porous material can be attached to a backing layer, as an alternative, a plurality of preformed porous materials can be attached. In embodiments where preformed porous materials are sized to substantially match the size of subarrays on the surface of a composite array, the distribution of preformed porous materials on a backing layer can correspond to the distribution of subarrays on the surface of a composite array. In certain embodiments, the distribution of preformed porous materials on the backing layer can correspond to the distribution of features on the surface of an array.

Layers other than a backing layer can also be attached to or directly contact the preformed porous material. For example, an additional intermediate layer or masking layer can be attached to the preformed porous material at locations where the preformed porous material does not contact the surface of the array. Alternatively, a masking layer can be attached to the preformed porous material at locations where the preformed porous material would normally be in fluid contact with the surface of the array if it were not for the presence of the masking layer. In such embodiments, the masking layer can preclude, or at least occlude, fluid contact between the preformed porous material and the surface of the array. Such masking can allow the selective transfer of substances between the preformed porous material and specific areas of the array surface. In certain embodiments, for example, where the preformed porous material is in fluid contact with a composite array, a masking layer can allow substances to be transferred between specific subarrays of a composite array and the preformed porous material.

Preformed porous materials that are attached to a backing layer or other layer can be composed of a variety of different materials and/or comprise different substances. For example, a plurality of preformed porous materials, each made of a different material or having a different pore size, can be attached to a backing layer, thereby providing a means by which to transfer different substances to and from different areas of the array surface. In preferred embodiments, a plurality of preformed porous materials attached to a backing layer in fluid contact with a composite array, can provide a means to transfer different substances to and from different subarrays on the array surface. In exemplary embodiments, a system is therefore provided that can deliver different substances to specific subarrays on the array surface.

In some embodiments, the preformed porous material also includes, or is in thermal contact with, a heating and/or cooling source that can be used to modify the temperature of the preformed porous material and/or array. Such heating and/or cooling source can be a device, composition or physical condition that can be used to conduct temperature sensitive reactions and/or incubations on the surface of the array and within the preformed porous material. Thus, in some embodiments, the temperature of the preformed porous material and/or array can be predetermined by the type of application or reaction that occurs. In exemplary embodiments, the temperature can be from about 0° C. to about 98° C., from about 10° C. to about 90° C., from about 25° C. to about 75° C., or from about 30° C. to about 60° C.

Temperature modification can be carried out using a variety of devices, compositions and/or physical conditions to heat or cool the preformed porous material and/or array, including, but not limited to, a chemical reaction, an electrical device, a fluidic device or another physical means. For example, in some embodiments a preformed porous material comprises reactants for an exothermic reaction in the case of heating, or an endothermic reaction in the case of cooling. In other embodiments, the preformed porous material can comprise a heating element or cooling element. For example, a peltier device can be included for temperature modification. Also contemplated are preformed porous materials in contact with heated or cooled fluids, for example, fluids in tubes around, within or throughout the preformed porous material. Heating or cooling the preformed porous material prior to contacting with the array is also contemplated. Additional embodiments can include placing the preformed porous material in fluid contact with the array in a temperature-modified chamber. Further embodiments can include placing the preformed porous material in close proximity to a heating/cooling source.

Temperature modification devices and compositions described herein may be part of a larger temperature regulation system that comprises a device or composition to modify the temperature of a preformed porous material as well as one or more thermosensors, feedback elements, and processors to adjust the temperature to a predetermined range. Temperature modification is particularly useful for embodiments utilizing PCR. Accordingly, a preformed porous material can be contacted with an array at temperatures used in PCR or other thermocycling techniques such as temperatures above 70° C. or above 95° C. and other temperatures as described, for example, in U.S. Pat. No. 4,683,195; Sambrook et al., Molecular Cloning: A Laboratory Manual, 3rd edition, Cold Spring Harbor Laboratory, New York (2001) or in Ausubel et al., Current Protocols in Molecular Biology, John Wiley and Sons, Baltimore, Md. (1998), each of which is incorporated herein by reference.

In some embodiments described herein, the preformed porous material can further comprise alignment moieties. Alignment moieties provide a mechanism by which to position a preformed porous material on the surface of the array. Various structures are contemplated whereby the position of the preformed porous material can be guided into position on the surface of the array. Furthermore, in some embodiments, both the array and preformed porous material can comprise alignment moieties. Examples of alignment moieties can include guidance pins in the array and/or preformed porous material, with guidance receptacles (for example, sockets or grommets) in the array and/or preformed porous material. In other embodiments, alignment moieties can include an array surface with ridges that allow the positioned fit of the preformed porous material on to the array.

With respect to reactions on the surface of the array, such reactions can include, but are certainly not limited to, binding reactions, hybridization reactions, sequencing reactions, chemical reactions and enzyme catalyzed reactions. With respect to reactions within the preformed porous material, such reactions can include, but are certainly not limited to, reactions to activate inactive temperature-sensitive species prior to transfer between the preformed porous material and the surface of the array.

Systems Comprising Arrays in Fluid Contact with a Preformed Porous Material

Systems comprising an array in fluid contact with a preformed porous material are also described herein. Such array systems permit the transfer a substance between a preformed porous material and an array. In some embodiments, the array system includes an array having a surface that is in fluid contact with a preformed porous material. In such embodiments, the array comprises a plurality of capture probes, which are usually associated either directly or indirectly with the array surface. In some embodiments, the array is a composite array (array of subarrays).

Array systems described herein can comprise a preformed porous material in fluid contact with an array surface, wherein the preformed porous material further comprises a backing layer. FIG. 2 illustrates an embodiment wherein a solid array (10) is in fluid contact with a preformed porous material (20), and wherein the porous material is attached to a backing layer (30). In certain embodiments, the backing layer can encase the preformed porous material while allowing the preformed porous material to remain in fluid contact with the surface of the array. FIG. 3 shows an array (10) and a preformed porous material (20) inset into a backing layer (30) having a depression (35) to accommodate the preformed porous material (20).

In still other embodiments, array systems can comprise a plurality of preformed porous materials in fluid contact with an array surface, wherein the plurality of preformed porous materials are attached to a backing layer. In some embodiments, the plurality of preformed porous materials can be attached to the backing layer in a pattern that corresponds to the location of groups of capture probes on the array surface. Similarly, in embodiments that include a composite array, the plurality of preformed porous materials can be attached to the backing layer in a pattern that corresponds to the location of subarrays on the array surface. In some of these embodiments, each preformed porous material of the plurality of preformed porous materials can comprise a different material and/or a different substance.

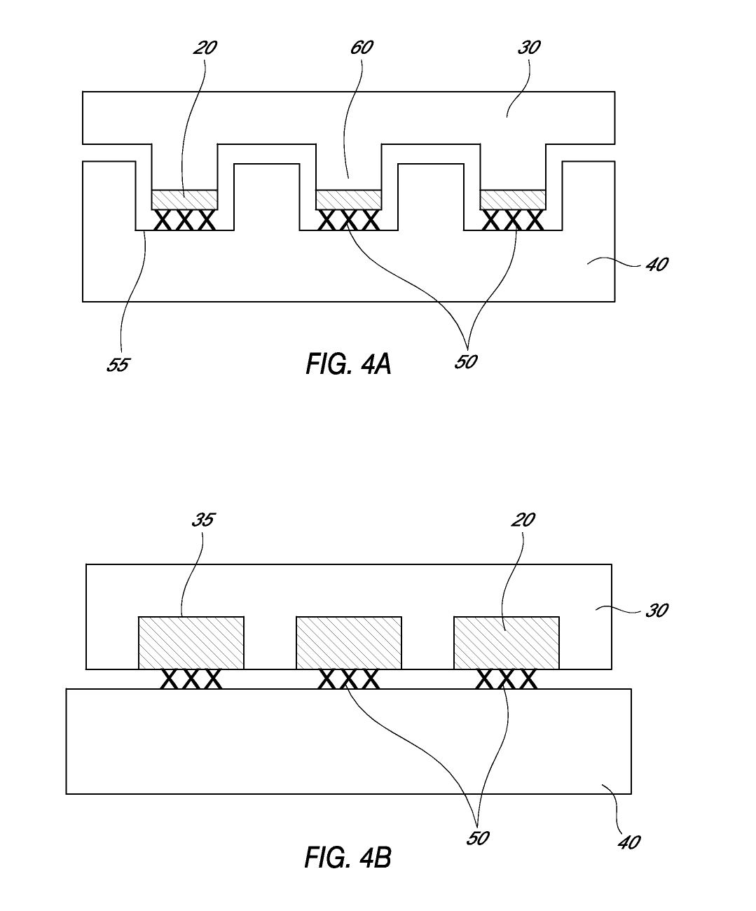

FIG. 4A shows a composite array (40) having capture probes (50) in depressions (55) and preformed porous materials (20) that fit into the depressions (55). The preformed porous materials (20) are attached to projections (60) extending from the backing layer (30). The projections (60) can be extensions of the backing layer (30) or alternatively made of an intermediate layer disposed between the backing layer and the preformed porous material. In a different embodiment, FIG. 4B shows an array of subarrays (40) with capture probes (50) and preformed porous materials (20) positioned over the capture probes (50). The preformed porous materials are inset into a backing layer (30) having a depression (35) to accommodate the preformed porous material (20).

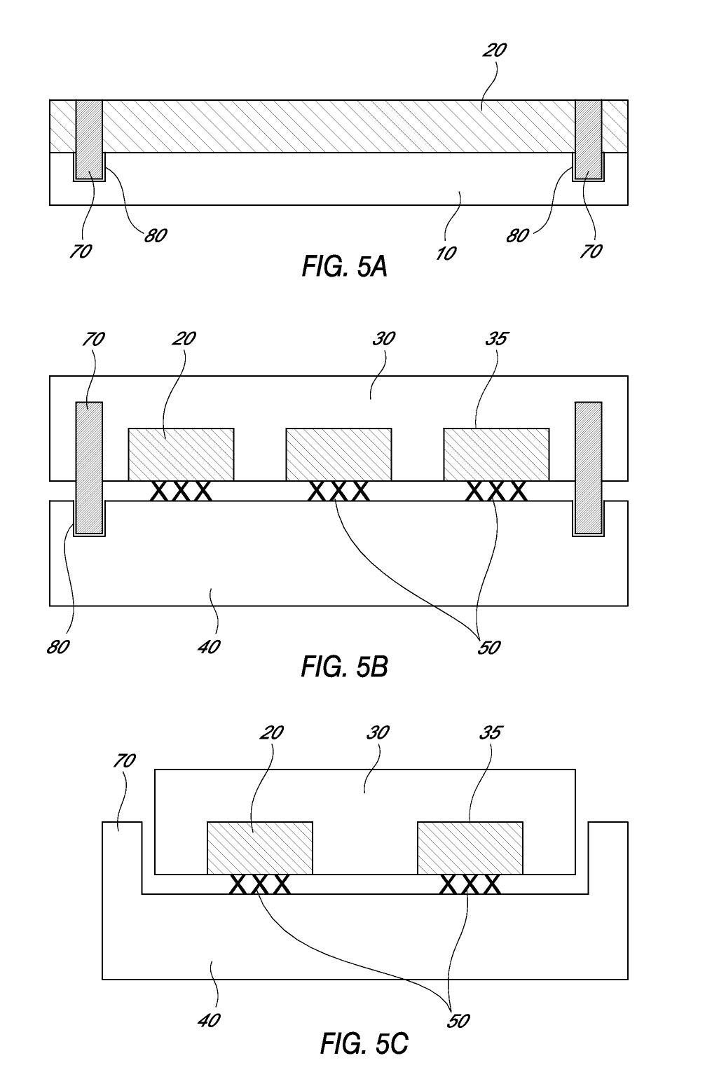

In further embodiments, systems comprising an array having a surface in fluid contact with a preformed porous material can further comprise alignment moieties. As described herein, alignment moieties provide a mechanism by which to position the preformed porous material on the surface of the array. FIG. 5 illustrates examples of alignment moieties. FIG. 5A shows an array (10) and porous material (20) with alignment moieties (70), which fit into alignment receptacles (80) on the array (10). FIG. 5B shows an array of subarrays (40) with capture probes (50) and preformed porous materials (20) positioned over the capture probes (50). The preformed porous materials are inset into a backing layer (30) having a depression (35) to accommodate the preformed porous material (20). The backing material also includes alignment moieties (70) which fit into alignment receptacles (80) on the array of arrays (40). FIG. 5C shows an array of subarrays (40) with capture probes (50) and preformed porous materials (20) positioned over the capture probes (50). The preformed porous materials are inset into a backing layer (30) having a depression (35) to accommodate the preformed porous material (20). The backing material is designed to fit between alignment moieties (70) which project from the array of arrays (40).

In additional embodiments, array systems comprising an array having a surface in fluid contact with a preformed porous material can further comprise a composition or device to modify the temperature of the preformed porous material and/or array. In some embodiments, the system can further comprise the components of a temperature regulation system as described previously.

Methods of Transferring a Substance to an Array using a Preformed Porous Material

Methods to transfer a substance between a preformed porous material and surface of an array are also provided herein. In some of these methods, an array is provided with a preformed porous material, such that the preformed porous material is in fluid contact with the array surface. In some such methods, the array is provided with more than one preformed porous material either separately or at the same time. In certain methods, the transfer of the substance between the preformed porous material and the array is facilitated by the use of pressure or other force.

Typically, a substance can be transferred between the surface of an array and a preformed porous material by providing the preformed porous material to the array surface, such that the array surface and preformed porous material are in fluid contact with each other. In preferred embodiments, a wetted preformed porous material is provided to the array such that the preformed porous material and array surface are in fluid contact with each other. In some embodiments, for example, where a preformed porous material comprises a dried or lyophilized substance, wetting the preformed porous material further provides a method to suspend or dissolve the substance before transfer to the array.

The time between wetting the preformed porous material and providing the wetted preformed porous material to the array can vary with the application. In some embodiments, the preformed porous material can be wetted prior to providing the preformed porous material to the surface of the array. In other embodiments, the preformed porous material can be wetted while in contact with the surface of the array, thereby creating the fluid contact between the surface of the array and the preformed porous material. The time between wetting the preformed porous material and providing the array with the wetted preformed porous material can be determined by factors such as, for example, the stability or shelf life of a substance in a preformed porous material comprising the wetted substance. Thus, in certain embodiments, the preformed porous material can be wetted while contacting the array, less than about 1 minute prior to contacting the array, less than about 10 minutes prior to contacting the array, less than about 1 hour prior to contacting the array, or less than about 3 days prior to contacting the array. In some embodiments, the preformed porous material can be wetted at the time of manufacturing the preformed porous material.

Wetting the preformed porous material can be preformed by a variety of methods, for example, by soaking the preformed porous material in a liquid, by pipetting a liquid on to the preformed material or by spraying a liquid on to the preformed porous material. In other embodiments, a liquid can be provided to a first performed porous material from a second preformed porous material in fluid contact with the first preformed porous material. In such embodiments, transfer of the liquid can be facilitated by any of a number of forces, including, for example, diffusion, gravity, cohesion, osmosis, and mechanical force.

The liquid used to wet the preformed porous material is typically compatible with the solvent or buffer used on the surface of the array. In some embodiments, the liquid comprises the same buffer or solvent as the buffer or solvent on the surface of the array. In other embodiments, the liquid used to wet the preformed porous material can be different from the liquid on the surface of the array.

The transfer of a substance between the preformed porous material and the surface of the array in fluid contact with one another, can be facilitated by passive or active forces. Examples of passive forces can include diffusion, osmosis, cohesion, adhesion, capillary action, and gravity. In exemplary embodiments, a substance can diffuse between the preformed porous material and the array. In some embodiments, the transfer of molecules between the preformed porous material and the surface of the array can be facilitated by an active force. In an exemplary embodiment, a compressive force can be applied to a preformed porous material, thereby moving the molecule to the surface of the array. In another exemplary embodiment, a compressive force can be released from a preformed porous material that is in fluid contact with the surface of the array, thereby allowing a molecule to move from the array to the preformed porous material. In further embodiments, the movement of a substance between the surface of an array and a preformed porous material can be facilitated by applying positive or negative pressure, for example, applying a vacuum to the surface of the array or to the porous material.

In certain embodiments, the surface of an array can be provided with one or more preformed porous materials. In some of these embodiments, a plurality of preformed porous materials can be stacked on the surface of an array. In other embodiments, a preformed porous material (first preformed porous material) in fluid contact with an array can be replaced with another preformed porous material (second preformed porous material).

With respect to embodiments where a plurality of preformed porous materials can be stacked on the array surface, the plurality of preformed porous materials can be in fluid contact with one another. The transfer of a substance between a porous material and another porous material and the surface of the array is thereby facilitated. In some embodiments, transfer is further facilitated by the use of compressive forces. In exemplary embodiments, a preformed porous material (first preformed porous material) is provided to an array such that the preformed porous material is in fluid contact with the array surface, an additional preformed porous material (second preformed porous material) is then provided to the first preformed porous material such that the additional preformed porous material is in fluid contact with the first preformed porous material. In additional exemplary embodiments, a further preformed porous material (third preformed porous material) is placed into contact with the additional preformed porous material (second preformed porous material). In an alternative embodiment, the additional preformed porous material (second preformed porous material) is replaced by the further preformed porous material (third preformed porous material).

Each preformed porous material stacked on to an array layer may comprise the same or a different material. In some embodiments, a mixture of the same preformed porous materials and different preformed porous materials can be used. In some embodiments, the preformed porous materials can comprise different substances. In an exemplary embodiment a first preformed porous material is provided to an array such that it is in fluid contact with the array surface. The first preformed porous material comprises an inactivated molecule, which is activated by providing a second preformed porous material, which comprises an activator molecule, such that it is in fluid contact with the first preformed porous material. As the activator molecule migrates from the second preformed porous material to the first preformed porous material, the inactivated molecule becomes activated.

With respect to embodiments where a preformed porous material is replaced by a second preformed porous material, each preformed porous material is in fluid contact with the array in succession. In such embodiments, the first preformed porous material in fluid contact with the array can be removed from the surface, and the second preformed porous material is then provided to the surface of the array such that the second preformed porous material is in fluid contact with the surface of the array. In preferred embodiments, the first preformed porous material and the second preformed porous material comprise different molecules. In other embodiments, the first preformed porous material transfers a sample to the surface of an array an the second preformed porous material transfers one or more reagents to the surface of the array. In another embodiment, the first preformed porous material transfers a substance to the surface of an array and the second preformed porous material removes the substance from the surface of the array.

The above-described methods can be used to initiate a binding reaction, such as binding one or more molecules with one or more capture probes on the array. In such reactions, a molecule is provided to the array by placing at least a first preformed porous material comprising one or more molecules to an array such that the preformed porous material is in fluid contact with the array surface. In such embodiments, the molecule is transferred to the array, thereby permitting the molecule to interact with one or more capture probes. If the molecule has sufficient affinity for the one or more capture probes, a binding reaction can occur. In some embodiments, a binding reaction is a reaction between proteins, such as a reaction of an epitope with an antibody or a receptor with a proteinacious ligand. In other embodiments, the binding reaction is an interaction between a protein and a small molecule, such as binding of an enzyme to a substrate or binding a receptor to a steroid ligand. In other embodiments, the interaction is between two or more small molecules. In still other embodiments, the interaction is between nucleic acids. In preferred embodiments, the capture probe is a nucleic acid and the molecule transferred or otherwise provided to the array via the preformed porous material is a nucleic acid, such as a target nucleic acid, a probe, a primer, or another oligonucleotide.

In embodiments where binding reactions are contemplated, the reactions can be performed under conditions other than ambient conditions. As discussed above, pressures other than ambient pressures can be applied to the preformed porous materials. In some embodiments, the preformed porous materials comprise a backing layer to facilitate the application of pressure. In another embodiment, binding reactions can be performed under reduced or elevated temperatures. In embodiments where temperature modifications are contemplated, a heating and/or cooling source can be included with, or otherwise applied to, the preformed porous material. In such embodiments, the heating and/or cooling source is in thermal contact with the preformed porous material. Such heating and/or cooling source can be a device, composition or other physical condition that can be used to modify the temperature of the preformed porous material and/or array. Such device, composition or other physical condition can be used to conduct temperature sensitive reactions and/or incubations on the surface of the array and within the preformed porous material. Thus, in some embodiments, the temperature of the preformed porous material and/or array can therefore be predetermined by the type of application or reaction that occurs. In exemplary embodiments, the temperature can be from about 0° C. to about 98° C., from about 10° C. to about 90° C., from about 25° C. to about 75° C., or from about 30° C. to about 60° C.

Temperature modification can be carried out using a variety of devices, compositions and/or physical conditions to heat or cool the preformed porous material and/or array, including, but not limited to, a chemical reaction, an electrical device, a fluidic device or another physical means. For example, in some embodiments a preformed porous material comprises reactants for an exothermic reaction, in the case of heating, or an endothermic reaction in the case of cooling. In other embodiments, the preformed porous material can comprise a heating element. Also contemplated are preformed porous materials in contact with heated or cooled fluids, for example, fluids in tubes throughout the preformed porous material. Heating or cooling the preformed porous material prior to contacting with the array is also contemplated. Additional embodiments can include placing the preformed porous material in fluid contact with the array in a temperature-modified chamber. Further embodiments can include placing the preformed porous material in close proximity to a heating/cooling source.

Temperature modification devices and compositions described herein may be part of a larger temperature regulation system that comprises a device or composition to modify the temperature of a preformed porous material as well as one or more thermosensors, feedback elements, and processors to adjust the temperature to a predetermined range.

### Kits Comprising an Array and a Preformed Porous Material

Kits comprising an array and a preformed porous material are also described herein. In the kits described herein the array typically comprises a plurality of capture probes. In some of the kits, the array is a composite array. The preformed porous material contained in the kits may or may not include a backing layer. Kits described herein can also be provided with or without a heating and/or cooling source.

In certain embodiments, kits described herein comprise a substance to be transferred to an array. In some embodiments, the substance is liquid. In some embodiments, the substance is supplied separate from the preformed porous material. In other embodiments, the preformed porous material can include the substance. In an exemplary embodiment, the preformed porous material comprises a molecule that is dried or lyophilized.

In embodiments where the substance is dried or lyophilized, the kit can further comprise a reconstitution solution. A reconstitution solution provides a means to resuspend or dissolve a substance to be transferred. In some embodiments, the reconstitution solution can comprise a liquid compatible with the liquid used on the surface of the array.

The kits described herein can also comprise at least one additional preformed porous material. In certain embodiments, the additional preformed porous material can comprise a different material and/or comprise a substance different from the first preformed porous material.

In still other embodiments, the kits described herein can further comprise a device or composition to modify the temperature of the preformed porous material and/or the array. In such embodiments, the preformed porous material can comprise the device or composition. In other embodiments, the device or composition to modify the temperature of the preformed porous material and/or the array is separate from the preformed porous material.

In some embodiments, the kits described herein can further comprise a precursor constituent of the preformed porous material. In such embodiments, the porous material can be preformed, prepared or assembled prior to contacting with the array from the precursor constituent. In some embodiments, for example, where the preformed porous material comprises a polymer, a kit can comprise precursor constituents of the polymer. In such embodiments, the density, volume, and pore size of the preformed porous material can be manipulated prior to use and according to the application.

### Multilayer Transfer Media

Multilayer transfer media relate to at least two porous materials coupled to each other, such that a surface of the first porous material is in contact with a surface of the second porous material. In such embodiments, typically the coupled surfaces are those having the largest surface area, however, the coupling of surfaces having less than the largest surface area are also contemplated. In preferred embodiments, the surface of the first porous material (surface of the first layer) is coupled to the surface of the second porous material (surface of the second layer) such that the surfaces are in fluid contact with each other. In some embodiments, a multilayer transfer medium is provided to an array, such that a surface of the multilayer transfer medium is in fluid contact with the array. In such embodiments, substances can be transferred between the multilayer transfer medium and the array.

In certain embodiments, the layers of a multilayer transfer medium can comprise the same material, different materials, or the same material with different characteristics resulting, for example, from a chemical or physical modification. In some embodiments, layers with different characteristics can be used to enrich each layer with a particular substance. In certain exemplary embodiments, a multilayer transfer medium is used as a molecular sieve. For example, the layers of the multilayer transfer medium can be gel matrices, wherein each layer has a different volume, density, or average pore size. In such embodiments, a layer with a specific average pore size can comprise a molecule of a particular molecular weight, whereas another layer, with a different average pore size, can comprise a substance with a different molecular weight. Thus, a large molecule in an upper layer of a multilayer transfer medium can be retained by a lower layer, thereby allowing the large molecule access to molecules present in lower layer but preventing the ultimate access of the large molecule to the array surface.

Multilayer transfer media with layers having different pore sizes can be exploited for differential delivery rates of differently sized substances to an array, much as occurs in gel permeation separation or size exclusion chromatography. For example, a layer having a pore size selected to control delivery rate can be loaded with substances of interest or can be placed between a loaded layer and the array. Accordingly, substances having sizes at or near the pore size of a particular layer will be delivered at a slower rate than substances that are substantially smaller than the pore size. Similarly, different pore sizes can provide directional delivery. For example, a first material that is directly contacted with an array can have relatively large pore size and can be loaded with a relatively large substance. A second material can be placed in direct contact with the first material (but not in direct contact with the array surface) and can be loaded with a relatively small substance. Under conditions of delivery (such as placing pressure on the multilayer transfer media, the larger substance will be prevented from entering the second layer due to the restrictive pore size and will therefore be driven to the array surface without being diluted into the volume of the second surface. Additionally or alternatively, the viscosity of delivery liquids can also be selected to influence rate and/or direction of delivering substances.

In further embodiments, the layers of a multilayer transfer medium can comprise the same or different substances. In some embodiments, different substances can be restricted to particular layers prior to providing the multilayer transfer medium to the array. Restricting substances to particular layers can be useful in various embodiments. For example, in certain embodiments, a particular layer can comprise an activator substance; another layer can comprise an inactive precursor substance. Activation of the inactive precursor may be desired just prior to providing the multilayer transfer medium to the array. In such embodiments, the activator and inactive precursor molecules are restricted to separate layers such that they are unable to diffuse across layers. For example, the molecules are dried or lyophilized, thereby keeping the molecules in separate layers separate until the transfer medium is wetted. In other examples, as described previously, molecules of particular molecular weight can be restricted to a layer by selecting an appropriate average pore size for the porous material constituting the layer.

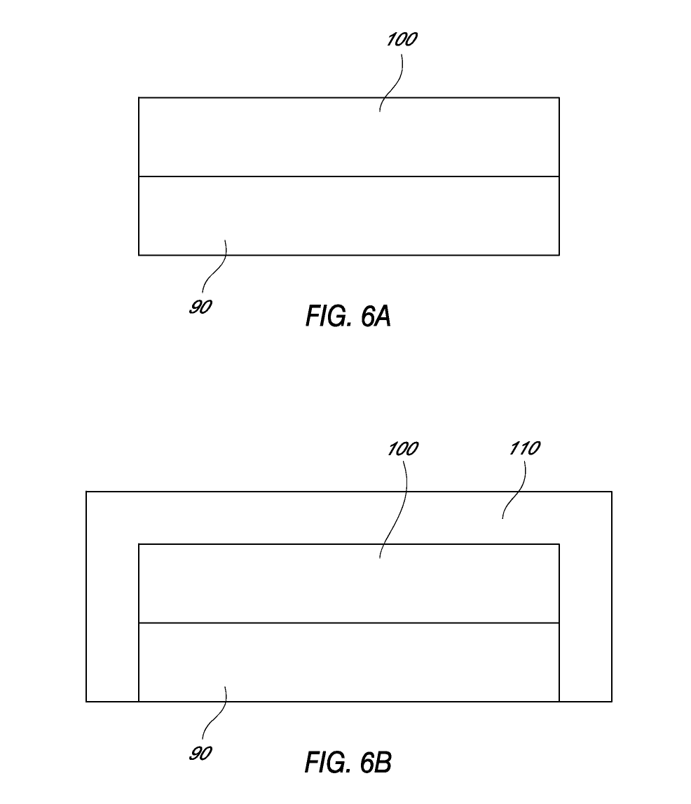

FIG. 6A illustrates an exemplary multilayer transfer medium comprising a first layer of porous material (90) in contact with a second layer of porous material (100). FIG. 6B shows a multilayer transfer medium comprising a first layer of porous material (90) attached to a backing layer (110) at one surface and in contact with a second layer of porous material (100) at another surface.

### Methods of Detecting Molecules

Also disclosed herein are methods of detecting one or more molecules using the array systems described previously. In preferred embodiments, a binding reaction can be detected between a molecule having been transferred to the array from a porous material and one or more capture probes on the surface of an array. In some embodiments, the preformed porous material can remain in fluid contact with the surface of the array during a binding reaction. In preferred embodiments, a binding reaction can be a nucleic acid hybridization. In other embodiments, the binding reaction can be an antibody/antigen reaction.

In some embodiments, different molecules can be transferred from a porous material to the surface of an array comprising a plurality of different capture probes and binding reactions between the different molecules and different capture probes can be detected. In preferred embodiments, the binding of at least 100 different molecules can be detected. In more preferred embodiments, the binding of at least 1,000,000 different molecules can be detected.

In some embodiments, a binding reaction can be detected by a variety of methods, such as by determining the change in a signal. For example, in some embodiments a sample comprising one or more molecules can be applied to an array using a preformed porous material. One or more target molecules in the sample can be detected by determining a change in a signal upon hybridization of the target molecule or by adding one or more molecules that produce a signal when the target molecule is bound to a capture probe but which do not produce a signal when no target molecule is bound. As such, in some embodiments, the detection methods described herein can be used to determine the presence or absence of one or more molecules in a sample. Detection can occur in the presence of a preformed porous material or the material can be removed prior to detection. For example, in embodiments utilizing optical methods, such as fluorescence detection, a material that is translucent to the excitation and emission wavelengths can be used, remaining in place during a detection step. Alternatively, if the material is not translucent in the desired wavelength range then excitation and emission can be detected in a way that avoids passage through the preformed porous material. For example, when a preformed porous material is placed on top of an array, emission and excitation can occur through the bottom of the array substrate.

In other embodiments, the detection methods described herein can be used to determine the nature or composition of an unknown substance or mixture. In some such embodiments, the detection methods described herein can be used to detect the presence of one or more nucleic acids or nucleic acid variants in a sample. In some embodiments, the sample can be obtained from organism, such as a human. In some such embodiments, the sample contains all or a portion of the genomic DNA of the organism or derivatives of the genomic DNA, including, but not limited to, mRNA, gDNA copies or adapter-linked gDNA copies and derivatives. In other embodiments, the sample can contain synthetic nucleic acids, which may or may not correspond to one or more nucleic acids present in one or more organisms.

In embodiments where nucleic acids are provided to an array, a sample comprising nucleic acids from one or more sources is applied to the preformed porous material which is provided to the array such that the preformed porous material is in fluid contact with the surface of the array. As with the application of any substance to an array using a preformed porous material, the preformed porous material can be provided to the array before, during or after the application of the nucleic acids to the preformed porous material. In some embodiments, a multilayer transfer medium is used to apply the nucleic acids to the array. In some embodiments, the capture probes on the array function as hybridization probes that bind to the nucleic acid sample applied to the array. The binding of a nucleic acid at any particular position can be detected by determining a change in a signal. Such methods are well known in the art. In other embodiments, the capture probes can function as primers permitting the priming a nucleotide synthesis reaction using a nucleic acid from the nucleic acid sample as a template. In this way, information regarding the sequence of the nucleic acids supplied to the array can be obtained. In some embodiments, nucleic acids hybridized to capture probes on the array can serve as sequencing templates if primers that hybridize to the nucleic acids bound to the capture probes and sequencing reagents are further supplied to the array. Methods of sequencing using arrays have been described previously in the art.

In particular embodiments, the methods of sequencing include sequencing-by-synthesis (SBS). In SBS, four fluorescently labeled modified nucleotides are used to determine the sequence of nucleotides for nucleic acids present on the surface of a support structure such as a flowcell. Exemplary SBS systems and methods which can be utilized with the apparatus and methods set forth herein are described in US Patent Application Publication No. 2007/0166705, US Patent Application Publication No. 2006/0188901, U.S. Pat. No. 7,057,026, US Patent Application Publication No. 2006/0240439, US Patent Application Publication No. 2006/0281109, PCT Publication No. WO 05/065814, US Patent Application Publication No. 2005/0100900, PCT Publication No. WO 06/064199 and PCT Publication No. WO 07/010251, each of which is incorporated herein by reference in its entirety.

In particular uses of the apparatus and methods herein, arrayed nucleic acids are treated by several repeated cycles of an overall sequencing process. The nucleic acids are prepared such that they include an oligonucleotide primer adjacent to an unknown target sequence. To initiate the first SBS sequencing cycle, one or more differently labeled nucleotides and a DNA polymerase can be introduced to the array, for example, by contacting the array with a preformed porous material having one or more of these reagents. Either a single nucleotide can be added at a time, or the nucleotides used in the sequencing procedure can be specially designed to possess a reversible termination property, thus allowing each cycle of the sequencing reaction to occur simultaneously in the presence of all four labeled nucleotides (A, C, T, G). Following nucleotide addition, the features on the surface can be detected to determine the identity of the incorporated nucleotide (based on the labels on the nucleotides). Then reagents can be added to remove the blocked 3′ terminus (if appropriate) and to remove labels from each incorporated base. The reagents can be added using a preformed porous material, if desired. Reagents, enzymes and other substances can be removed between steps by washing, optionally using a preformed porous material to deliver wash solution and or to remove solutions form the array. Such cycles are then repeated and the sequence of each cluster is read over the multiple chemistry cycles.

It will be understood that in embodiments where multiple steps of liquid delivery or removal are used, such delivery can occur using a preformed porous material at all steps of the process or some of the steps can use other types of fluid handling. Thus, taking SBS as an example, some reagents can be delivered via preformed porous materials while washing steps can be carried out using flow of wash solutions over the array surface.

Other sequencing methods that use cyclic reactions, wherein each cycle can include steps of delivering one or more reagents to nucleic acids on a surface using a preformed porous material include, for example, pyrosequencing and sequencing-by-ligation. Useful pyrosequencing reactions are described, for example, in US Patent Application Publication No. 2005/0191698 and U.S. Pat. No. 7,244,559, each of which is incorporated herein by reference. Sequencing-by-ligation reactions are described, for example, in Shendure et al. Science 309:1728-1732 (2005); U.S. Pat. No. 5,599,675; and U.S. Pat. No. 5,750,341, each of which is incorporated herein by reference in its entirety.

In embodiments wherein random arrays are used, one or more molecules used in array decoding can be provided to the array using a preformed porous material or multilayer transfer medium either prior or subsequent to detecting the binding of one or more target molecules to one or more capture probes on a surface of the array. Methods of decoding random arrays are described in, for example, U.S. Pat. No. 7,060,431, the disclosure of which is incorporated herein by reference in its entirety. In brief, a decoding allows one to determine the position and identity of specified capture probes on random arrays. This is particularly useful when a mixture of target molecules are supplied to the array together at substantially the same time because it provides a means to determine the identity of the target molecules present in the sample.

The preformed porous materials, methods of their manufacture and methods of their use as described herein are also useful for genotyping assays, expression analyses and other assays known in the art such as those described in US Patent Application Publication No. 2003/0108900, US Patent Application Publication No. 2003/0215821 and US Patent Application Publication No. 2005/0181394, each of which is incorporated herein by reference in its entirety. A preformed porous material can be used to deliver or remove reagents in the various assay methods described in these references.

The description above has focused on embodiments in which a preformed porous material is provided to a surface. However, a precursor material capable of forming a porous material can also be used. For example, the precursor material can be contacted with a surface and the precursor can be allowed to form a porous material. Thus, the methods, compositions and kits exemplified above with respect to a preformed porous material can utilize one or more precursor materials in place of the exemplified preformed porous material.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

All references cited herein including, but not limited to, published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

1.-105. (canceled)

106. A method of transferring a molecule to an array, said method comprising:
obtaining an array having a surface, wherein said array comprises a plurality of capture probes;
obtaining a preformed porous material, wherein said preformed porous material comprises said molecule; and
providing said preformed porous material to said surface such that said material is in fluid contact with said surface, thereby transferring said molecule to said array.

107. The method of claim 106, wherein said preformed porous material comprises a fibrous material.

108. The method of claim 106, wherein said preformed porous material comprises a gel matrix.

109. The method of claim 106, wherein said preformed porous material is attached to a non-porous backing.

110. The method of claim 106, wherein said molecule is dissolved or suspended in a liquid.

111. The method of claim 106, wherein said molecule is dried or lyophilized.

112. The method of claim 106, wherein said molecule is a protein.

113. The method of claim 112, wherein said protein is an enzyme used for nucleic acid sequencing.

114. The method of claim 106, wherein said providing the preformed porous material to the surface further comprises applying pressure to the porous material.

115. The method of claim 106, further comprising performing a binding reaction by allowing the molecule to bind with at least one of said capture probes.

116. The method of claim 115, wherein said preformed porous material is in fluid contact with the surface during the binding reaction.

117. The method of claim 115, wherein said preformed porous material comprises different molecules that bind to different capture probes of said plurality of capture probes.

118. The method of claim 106, further comprising removing said preformed porous material from said array, thereby removing fluid from said array.

119. The method of claim 106, further comprising providing an additional porous material to said array.

120. The method of claim 119, wherein said additional porous material contacts said preformed porous material.

121. The method of claim 119, wherein said preformed porous material is removed prior to providing said additional porous material to said array.

122. The method of claim 106, wherein said preformed porous material is smaller than the area of said surface of the array.

123. A kit for transferring a molecule to an array, said kit comprising:
an array having a surface, wherein said surface comprising a plurality of capture probes; and
a preformed porous material, wherein said preformed porous material comprises a molecule.

124. A method for detecting a molecule, said method comprising:
obtaining an array having a surface, wherein said array comprises a plurality of capture probes;
obtaining a preformed porous material, wherein said preformed porous material comprises said molecule;
providing said preformed porous material to said surface such that said preformed porous material is in fluid contact with said surface, whereby said molecule becomes bound to at least one of said capture probes of said array; and
detecting said molecule bound to said capture probe.

125. A array system comprising:
an array having a surface, wherein said array comprises a plurality of capture probes; and
a preformed porous material comprising a molecule, said preformed porous material being in fluid contact with said array.
